(19) United States
(12) Patent Application Publication
(10) Pub. No.: US 2024/0385323 A1
(43) Pub. Date: Nov. 21, 2024

(54) PROXIMITY SENSING DEVICE

(71) Applicant: STMicroelectronics International N.V., Geneva (CH)

(72) Inventors: Thomas Perotto, Grenoble (FR); Charlotte Milanetto, Grenoble (FR)

(21) Appl. No.: 18/648,988

(22) Filed: Apr. 29, 2024

(30) Foreign Application Priority Data
May 17, 2023 (FR) 2304948

(51) Int. Cl. G01S 17/08; G01S 7/481

(52) U.S. Cl. CPC G01S 17/08; G01S 7/4813; G01S 7/4816

(57) ABSTRACT

A proximity sensing device includes a proximity sensor including a light source, a light detector including a first photodiode adapted to generate a first signal, and a second photodiode adapted to generate a second signal, the second photodiode and the light source being separated from the first photodiode with a separator. The proximity sensing device further includes a selecting circuit adapted to compare the first signal to the second signal, and to select a signal from the first and second signals according to the executed comparison.

### CROSS-REFERENCE TO RELATED APPLICATIONS

This application claims the priority benefit of French patent application number 2304948, filed on May 17, 2023, entitled “Dispositif de capture de proximité”, which is hereby incorporated by reference in its entirety.

### TECHNICAL FIELD

The present disclosure relates generally to electronic devices, and more particularly to electronic devices with a proximity sensor.

### BACKGROUND

A proximity sensor comprises generally a light source, and a light detector. The general principle of a proximity sensor lays in the emission by the source of a light beam, for example an infrared beam, being reflected by an object, and captured in return by the detector. The detector can include one photodiode, or several photodiodes. The proximity sensor can be coupled with, or comprise, a processing unit, configured to process a signal from the detector for a calculation of proximity detection. For example, the signal can have a value, or an intensity, such as a magnitude or a pulse number, varying as a function of the distance between the object and the detector, and the processing unit can process this signal to deduce the presence of an object proximate a proximity sensor or not.

The proximity sensor can be of the time of flight (ToF) sensor type, and, in such case, the processing unit can be configured to calculate the time of travel between the transmitting of the light and its reception by the detector, the distance between the object and the proximity sensor being then deductible based on this travel time.

### SUMMARY

In accordance with an embodiment, a proximity sensing device includes a proximity sensor including a light source, a light detector including a first photodiode adapted to generate a first signal, and a second photodiode adapted to generate a second signal. The second photodiode and the light source is separated from the first photodiode with a separator. The proximity sensing device further includes a selecting circuit adapted to compare the first signal to the second signal, and to select a signal from the first and second signals according to the executed comparison. In an embodiment, the first photodiode is adapted to generate the first signal when it detects a first light signal transmitted from the light source and reflected by an object, and the second photodiode is adapted to generate the second signal when it detects a second light signal transmitted from the light source and reflected by the object. In an embodiment, the selecting circuit includes a comparator adapted to compare the first and second signals with each other. In an embodiment, the selecting circuit is configured to generate a selecting signal communicating the selected signal. In an embodiment, the selected signal is the second signal if the difference between the second signal and the first signal is higher than a threshold, or the first signal if the difference between the second signal and the first signal is lower than the threshold, the threshold being equal to around zero. In an embodiment, the selecting circuit is adapted to generate a corrected signal taking a value of the selected signal. In an embodiment, the proximity sensing device further includes a processing device configured to generate a proximity-detection signal according to the signal selected by the selecting circuit. In an embodiment, the processing device is adapted to retrieve the corrected signal, the proximity-detection signal being a function of the corrected signal. In an embodiment, the processing device is coupled to the selecting circuit, or includes the selecting circuit. In an embodiment, the processing device is coupled to the first and second photodiodes. In an embodiment, the light source, the light detector, and the second photodiode are disposed under a capping wall of the proximity sensor, the capping wall including a top wall of a housing accommodating the light source, the light detector, and the second photodiode. In an embodiment, the second photodiode and the light source are disposed side by side along a direction substantially parallel to a plane of the capping wall. In an embodiment, the capping wall includes a first opening corresponding to the light source, a second opening corresponding to the first photodiode of the light detector, the second photodiode being substantially disposed under a non-open portion of the capping wall. In an embodiment, the second photodiode is disposed between the light source and the first photodiode. In an embodiment, the light source, the second photodiode, and the light detector are disposed in a housing comprising a first cavity and a second cavity separated from the first cavity with the separator, the light source and the second photodiode being disposed in the first cavity, and the light detector being disposed in the second cavity.

In accordance with another embodiment, a proximity sensing device includes a housing including a first cavity and a second cavity. The first cavity is separated from the second cavity with a separator. The proximity sensing device includes a proximity sensor. The proximity sensor includes a light source disposed within the first cavity and a light detector disposed within the second cavity. The light detector includes a first photodiode adapted to generate a first signal. The proximity sensor further includes a second photodiode within the first cavity. The second photodiode is adapted to generate a second signal. The proximity sensing device further includes a selecting circuit coupled to the proximity sensor. The selecting circuit includes a comparator adapted to compare the first signal to the second signal, and to select a signal from the first and second signals according to the executed comparison. The proximity sensing device further includes a processing device coupled to the selecting circuit. The processing device is configured to generate a proximity-detection signal according to the signal selected by the selecting circuit.

In accordance with yet another embodiment, a method for detecting proximity implementing a proximity sensing device including a proximity sensor comprising a light source, a light detector including a first photodiode, and a second photodiode, the second photodiode and the light source being separated from the first photodiode with a separator, the method includes, using a selecting circuit, comparing a first signal generated by the first photodiode with a second signal generated by the second photodiode, and selecting a signal from the first and second signals according to the executed comparison. In an embodiment, the method further includes generating, by the first photodiode, the first signal when the first photodiode detects a first light signal transmitted from the light source and reflected by an object, and generating, by the second photodiode, the second signal when the second photodiode detects a second light signal transmitted from the light source and reflected by the object. In an embodiment, the method further includes, using the selecting circuit, generating a corrected signal taking a value of the selected signal, and communicating the corrected signal to a processing device coupled to the selecting circuit. In an embodiment, the selected signal is the second signal if the difference between the second signal and the first signal is higher than a threshold, or the first signal if the difference between the second signal and the first signal is lower than the threshold, the threshold being equal to around zero.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1A illustrates an example proximity sensor in a first configuration;

FIG. 1B illustrates the proximity sensor shown in FIG. 1A in a second configuration;

FIG. 1C illustrates the proximity sensor shown in FIG. 1A in a third configuration;

FIG. 2A and FIG. 2B illustrate graphs showing an application of a proximity sensor, for example the proximity sensor shown in FIG. 1A to switch off or on a display screen;

FIG. 3A illustrates a proximity sensing device according to one embodiment in a first configuration;

FIG. 3B illustrates the proximity sensing device shown in FIG. 3A in a second configuration;

FIG. 4 illustrates, with a flowchart, an example proximity detection method implementing a proximity sensing device according to one embodiment; and

FIG. 5 illustrates an example graph, obtained by simulating, showing signals generated when implementing the method shown in FIG. 4 as a function of the distance between the proximity sensor and an object.

### DETAILED DESCRIPTION OF ILLUSTRATIVE EMBODIMENTS

Like features have been designated by like references in the various figures. In particular, the structural and/or functional features that are common among the various embodiments might have the same references and might dispose identical structural, dimensional and material properties.

For the sake of clarity, only the operations and elements that are useful for an understanding of the embodiments described herein have been illustrated and described in detail. In particular, all components of an electronic device integrating a proximity sensor have not been described in detail, the described embodiments being compatible with the usual electronic devices integrating a proximity sensor. Similarly, all components of a proximity sensor have not been described in detail, the described embodiments being compatible with the usual proximity sensors. Further, processing the signals of a proximity sensor to generate a proximity-sensing signal has not been described in detail, the described embodiments being compatible with usual methods for processing the signals of a proximity sensor.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures, or to a proximity sensor as orientated during normal use.

Unless specified otherwise, the expressions “around”, “approximately”, “substantially” and “in the order of” signify within 10%, and preferably within 5%.

Light transmittance, or transmission coefficient, of an element is defined as the part of the light intensity passing through this element.

It was noticed that a proximity sensor might fail in differentiating whether an object is at a very short distance (very near object), typically a few millimetres, for example less than 5 millimetres, or a long distance (far object), typically more than a few centimetres, e.g. more than 40 millimetres, from said sensing device.

This difficulty or incapacity in differentiating an object at a very short distance from an object at long distance can be an issue in some applications, for example when a proximity sensor is located under a display screen, and that it is configured to switch the screen off if an object, or an user, is at very short distance from the sensing device, or to switch it on if the object, or the user, is at very far distance from the sensing device. The difficulty in differentiating an object at a very short distance from an object at long distance can jeopardize the switching on and/or off of the display screen.

There is a need for an electronic device with a proximity sensor capable of determining a far or very short distance object. One also seeks for a proximity sensing device, i.e. an electronic device with a proximity sensor, capable of determining whether an object is at a far or very short distance, preferably using a solution easy to implement.

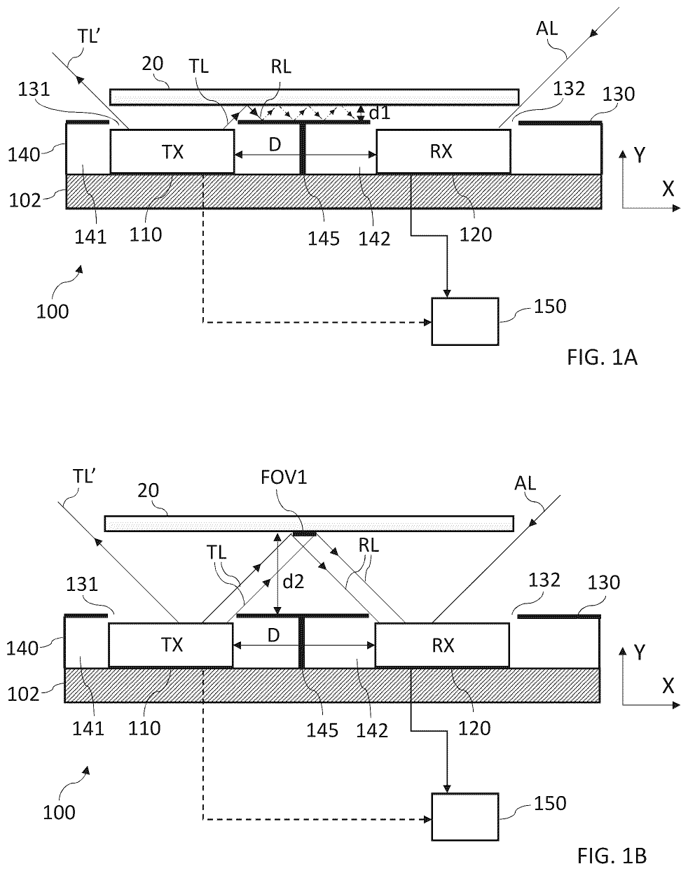

FIG. 1A illustrates an example proximity sensor 100 in a first configuration. FIG. 1B illustrates the proximity sensor shown in FIG. 1A in a second configuration. FIG. 1C illustrates the proximity sensor shown in FIG. 1A in a third configuration.

The proximity sensor 100 comprises a light source 110 (TX) and a light detector 120 (RX) situated on a substrate 102, and under a capping wall 130, corresponding in the illustrated example to an upper wall of a housing 140 accommodating the source and the detector. The wall 130 can be a cover glass. The source 110 and the detector 120 are separated with a separating wall 145 (separator) vertically extending in the housing 140 from the substrate 102 up to the wall 130. Thus, the housing 140 includes a first cavity 141 accommodating the source 110, and a second cavity 142 accommodating the detector 120, first and second cavities being separated with a separating wall 145.

The wall 130 includes two openings 131, 132, a first opening 131 in regard of the source 110, and a second opening 132 in regard of the detector 120.

The proximity sensor 100 can comprise, or be coupled with, a processing device 150 configured to process the signals generated by the detector 120, to deliver a proximity-detection signal (detection signal). The processing device 150 is coupled with the detector 120. The detection signal can have a value, or an intensity, for example a magnitude or a pulse number or counts, varying as a function of the distance separating an object 20 and the proximity sensor 100. The processing device 150 can process the signals generated by the detector 120, for example count the pulses, in order to deduce whether the object is at very short distance, mean distance or very long distance from the proximity sensor. The processing device 150 can also be coupled with the source 110, for example in order to calculate a time of flight.

In operation, the source 110 transmits a light signal TL through the first opening 131. The light signal can be reflected by an object 20 (light signal RL).

In the first configuration shown in FIG. 1A, the object 20 is at a first distance d1, for example a very short distance, from the proximity sensor 100. One observes that the reflected light signal RL comes impacting the wall 130, but due to the object 20 being proximate, it does not, or in any case not directly, reach the light detector 120 which receives however an ambient light signal AL. Optionally, the reflected light signal RL might reach the light detector thanks to consecutive reflections between the object 20 and the wall 130, but then its intensity can be reduced as much as high the number of reflections.

One might assume reducing the distance D between the source 110 and the detector 120, and bringing the first and second openings 131, 132 together. However, by bringing the source 110 and the detector 120 together, one might be faced with a crosstalk phenomenon, consisting in the transmission of a light signal from the source 110 towards the detector 120 by reflecting on a surface of the wall 130, or within the wall itself, without propagating this light signal outside of the housing 140 towards the object 20, even if this phenomenon might be restricted by the provision of the separator 145.

In the second configuration shown in FIG. 1B, the object 20 is at a second distance d2 from the proximity sensor 100 higher than the first distance d1, for example an average distance. One observes that the reflected light signal RL reaches the detector 120 through the second opening 132. The field of view FoV1 of the object 20 from the sensing device 100 can be small due to the length of the wall 130 between the first and second openings 131, 132, which can be function of the distance D between the source 110 and the detector 120.

In the third configuration shown in FIG. 1C, the object 20 is at a third distance d3 from the proximity sensor 100 higher than the second distance d2, for example a long distance. The reflected light signal RL reaches the detector 120 through the second opening 132, and the field of view FOV2 of the object 20 from the sensing device 100 is increased as respect to the field of view FOV1 of the second configuration.

In the second and third configurations, the detector 120 can also detect an ambient light signal AL in addition to the reflected light signal RL.

In the three configurations, the source might transmit a light signal TL′ not being reflected by the object 20.

In some cases, the proximity sensor 100 can be disposed under a display screen (not shown), for example a screen of the organic light-transmitting diode (OLED) type, so that the wall 130 is disposed between the source/detector and the display screen, and the display screen is disposed between the proximity sensor 100 and the object 20.

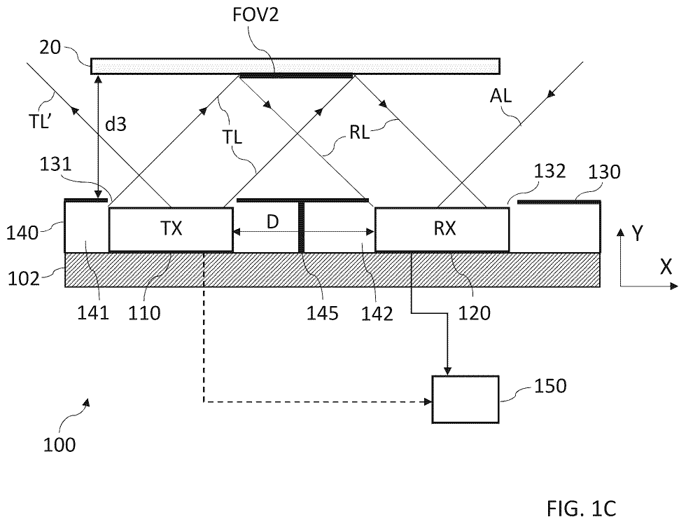

FIG. 2A and FIG. 2B illustrate graphs showing an application of a proximity sensor, for example the proximity sensor 100 shown in FIG. 1A, to switch off or on a display screen.

In each of FIGS. 2A and 2B, is illustrated a set of “points”, set 210 in FIG. 2A and set 220 in FIG. 2B, the “points” illustrating output signals of the proximity sensor, as a number of counts as a function of the distance in millimetres between the proximity sensor and an object (Target distance). The “points” can be elongated, and form vertical bars, which can be due to the use of several measurement samples and/or a dispersion among the results of the measurement samples.

In the represented application, the detection signals generated by the proximity sensor are forwarded to a display screen (DISPLAY), or to a control circuit of the display screen, in order to switch off (DISPLAY OFF) or on (DISPLAY ON) the display screen according to said detection signal. The display screen can be the display screen of a mobile phone such as a smartphone, the proximity sensor being under the display screen, and the object can be an organ, such as an ear, of a user of the mobile phone.

In the operation of FIG. 2A, the detection signal 210 increases as the objects comes closer to the proximity sensor, i.e. when the distance between the object and the proximity sensor decreases, and the detection signal decreases as the object moves away from the proximity sensor, i.e. when the distance between the object and the proximity sensor increases.

If the detection signal rises above a detection threshold (THD), when the object comes closer to the proximity sensor below a fourth distance d4, it can trigger the switching off of the screen (DETECTED). The screen can remain switched off as long as the detection signal remains above the detection threshold THD. If the detection signal decreases again below the detection threshold THD, when the object moves away from the proximity sensor beyond the distance d4, it can trigger the switching on of the screen (RELEASED).

Alternatively, when the detection signal has moved above the detection threshold, the screen can stay switched off as long as the detection signal stays above another threshold, being referred to as triggering threshold, less than the detection threshold, corresponding to a distance higher than the fourth distance d4. An offset between the detection threshold and the triggering threshold can be defined to obtain a stable operation of the hysteresis-type.

The operation represented in FIG. 2A is a perfect, or at least expected, operation in which the detection signal substantially follows a law of the type of the inverse of the square of the distance. However, this perfect operation is not always observed, as shown in FIG. 2B.

In the operation as shown in FIG. 2B, as long as above a fifth distance d5 less than the fourth distance d4, the detection signal 220 rises when the object moves closer to the proximity sensor, i.e. as the distance between the object and the proximity sensor decreases down to the fifth distance d5, and the detection signal falls when the object moves away from the proximity sensor, i.e. as the distance between the object and the proximity sensor increases from the fifth distance d5.

However, below the fifth distance d5, the trend reverses: the detection signal 220 decreases as the distance decreases from the fifth distance d5, and it rises as the distance increases up to the fifth distance d5.

The fifth distance d5 shown in FIG. 2B is equal to around 9-10 millimetres, but the fifth distance might have other values, for example be less than 9 millimetres, or higher than 10 millimetres, depending on to the proximity sensor.

This reversal can be explained by referring back to FIGS. 1A-C, particularly the first configuration shown in FIG. 1A in which the object 20 is very close to the proximity sensor 100, and where the detector 120 can receive no more light signal, or receive light signals having a lower intensity, for example by consecutive reflections between the object 20 and the wall 130. One can consider that the first distance d1 is less than the fifth distance d5. One can also consider that the second distance d2 shown in FIG. 1B, and a fortiori the third distance d3 shown in FIG. 1C, is higher than the fifth distance d5, and is back the trend according to which the detection signal rises as the distance between the object and the proximity sensor decreases, and decreases as the distance between the object and the proximity sensor increases. For example, the detection signal might all the more increase as the field of view of the object from the proximity sensor increases.

Further, the provision of a display screen, of the OLED type or more generally a low transmittance screen, the proximity sensor being under the screen, might influence this reversal phenomenon.

As a result of this reversal, the intensity of the detection signal can be sensibly the same whatever the distance is short, e.g. less than 9 or 5 millimetres, or long, e.g. higher than 30 or 40 millimetres, as can be seen in FIG. 2B.

One should understand that it might cause turning the screen back on, since the detection signal can be below the detection threshold THD, while the distance is still very short, and that the screen should then not be turned back on.

The present disclose describes a proximity sensing device, i.e. a device comprising a proximity sensor, allowing all or some of the previously described drawbacks to be addressed, particularly the issue in detecting a very close object, for example in differentiating between a very close object and a far object, to be solved, and this preferably using a solution easy to implement.

Embodiments of proximity sensing devices are to be hereinafter described. The described embodiments are given by way of illustration and not limitation, and many variants will readily occur to those skilled in the art based on the teachings of the present disclosure.

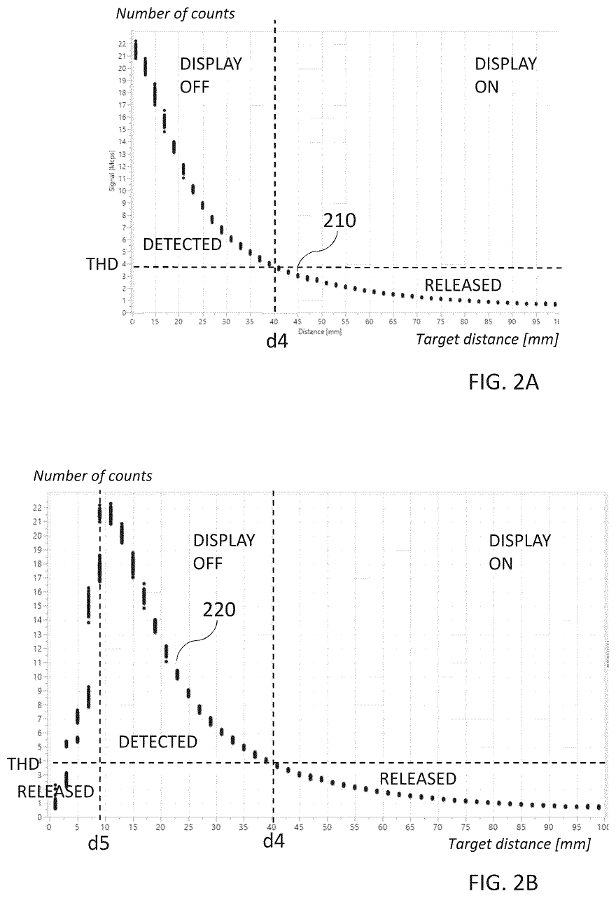

FIG. 3A illustrates a proximity sensing device 300 according to one embodiment in a first configuration, and FIG. 3B illustrates the proximity sensing device 300 shown in FIG. 3A in a second configuration.

The proximity sensing device 300 includes a proximity sensor 302 comprising, like the proximity sensor 100 shown in FIG. 1A, a light source 110 (TX) and a light detector (RX) 120 located on a substrate 102 and under a capping wall 130, corresponding in the illustrated example to an upper wall of a housing 140 accommodating the source and the detector. The wall 130 might be a cover glass. The source 110 and the detector 120 are separated with a separating wall 145 vertically extending in the housing 140 from the substrate 102 up to the wall 130. Thus, the housing 140 includes a first cavity 141 including the source 110, and a second cavity 142 including the detector 120, the first and second cavities being separated with the separating wall 145.

The source 110 can include a light transmitting diode (LED) or a vertical cavity surface emitting laser (VCSEL).

Detector 120 comprises a first photodiode 320 (PDr). Alternatively, the detector 120 might comprise several first photodiodes.

The proximity sensor 302 further comprises a second photodiode 310 (PDt) arranged in the first cavity 141 including the source 110. Alternatively, the proximity sensor 302 might comprise several second photodiodes in the first cavity 141.

Thus, the source 110 and the second photodiode 310 are separated from the first photodiode 320 with the separating wall 145.

The first and/or second photodiodes might be pinned photodiodes, avalanche photodiodes, or single photon avalanche detectors (SPAD).

The wall 130 includes two openings: a first opening 131 in regard of the source 110, and a second opening 132 in regard of the detector 120, for example facing the first photodiode 320.

The second photodiode 310 might be all or part arranged under a non-open part of the wall 130. In other words, at least a part of the second photodiode 310 might be covered with the wall 130.

In the illustrated example, the source 110 and the second photodiode 310 are arranged side by side, along a direction X sensibly parallel to the plane of the wall 130, but other configurations might be considered by those skilled in the art.

The first photodiode, respectively the second photodiode, is adapted to detect a first, respectively a second, light signal transmitted from the source 110, then reflected by an object 20. By detecting the first reflected light signal, the first photodiode 320 is adapted to generate a first signal S_{PDr}, and by detecting the second reflected light signal, the second photodiode 321 is adapted to generate a second signal S_{PDt}.

The proximity sensing device 300 further comprises a selecting circuit 330 adapted to receive the first signal S_{PDr} and the second signal S_{PDt}, and to select a signal from said first and second signals, for example the signal having a higher intensity. For example, the selecting circuit 330 is adapted to output a selecting signal S_{SEL} indicating, or communicating, the selected signal.

The selecting circuit 330 might comprise a comparator 332 adapted to compare the first and second signals with each other so as to determine which signal from the first and second signals is selected, and to deliver the selecting signal S_{SEL}.

The selecting circuit 330 can deliver a corrected signal S_{COR} that can have the value of the selected signal, for example, the value of the second signal S_{PDt} if the difference between the second signal and the first signal (S_{PDt}-S_{PDr}) is higher than a threshold, or the value of the first signal S_{PDr} if the difference between the second signal and the first signal (S_{PDt}-S_{PDr}) is less than the first threshold. For example, the threshold is equal to zero and the corrected signal corresponds to the second signal S_{PDt} if the second signal has an intensity higher than the first signal, or to the first signal S_{PDr} if the second signal has an intensity less than the first signal. The corrected signal S_{COR} can be a signal separate from the selecting signal S_{SEL}. Alternatively, the selecting signal S_{SEL} might include the corrected signal S_{COR}.

The proximity sensing device 300 might comprise a processing device 350 that can be coupled with the selecting circuit 330.

The processing device 350 can be configured to generate a proximity-sensing signal S_{PS} (detection signal) according to the selected signal by the selecting circuit 330, for example according to the first signal S_{PDr} provided by the first photodiode 320, to the second signal S_{PDt}provided by the second photodiode 310, to the selecting signal S_{SEL} provided by the selecting circuit 330, and/or to the corrected signal S_{COR} provided by the selecting circuit 330. For example, the detection signal S_{PS} can be generated based on the first signal S_{PDr} if the selecting circuit 330 selects this first signal, or based on the second signal S_{PDt} if the selecting circuit 330 selects this second signal.

The processing device 350 can retrieve the selected signal from the first signal S_{PDr} and the second signal S_{PDt} via the selecting circuit 330, for example by retrieving the corrected signal S_{COR} provided by the selecting circuit 330.

Alternatively, the processing device 350 can retrieve the selecting signal S_{SEL}, and retrieve the selected signal directly by the first or the second photodiode. The processing device 350 is then preferably coupled with the first and second photodiodes 320, 310 (dotted arrows in FIG. 3A).

The processing device 350 can be coupled with the proximity sensor 302, or be included in the proximity sensor 302. The detection signal S_{PS} can have a value, or an intensity, for example a magnitude or a number of pulses or counts, varying as a function of the distance separating the object 20 and the proximity sensor 302.

The represented selecting circuit 330 is included in the proximity sensing device 300 and coupled with the proximity sensor 302, particularly with the first and second photodiodes 320, 310. This is not a limitation, and other configurations are possible. Alternatively, the selecting circuit 330 might be included in the proximity sensor 302, for example in the processing device 350.

The proximity sensor 302 can be of the time-of-flight (ToF) sensor type, and the processing device 350 can then be configured to calculate a travel time between transmitting the light signal and receiving it using the signal selected from the first and second signals, the distance between the object 20 and the proximity sensor 302 being then deducible based on this travel time. The processing device 350 can then be also coupled with the transmitter 110 (mixed line arrow in FIGS. 3A and 3B).

The proximity sensor 302 can operate at infrared (IR) light, or near infrared (NIR) light, for example between 850 and 950 nm, e.g. around 940 nm.

In the first configuration shown in FIG. 3A, the object 20 is at a first distance d1 from the proximity sensor 302, for example a very short distance. One sees that, among the transmitted light signals TL from the source 110, some are reflected from the object 20, and reflected light signals RL reach in return the second photodiode 310 through the first opening 131, but do not reach, at least not directly, the first photodiode 320. In this first configuration, the second signal S_{PDt} would undoubtedly have a higher intensity than the first signal S_{PDr}.

In the second configuration shown in FIG. 3B, the object 20 is at a second distance d2 from the proximity sensor 302 higher than the first distance d1, for example an average distance. One sees that, among the transmitted light signals TL from the source 110, some are reflected from the object 20, and reflected light signals RL reach in return the first photodiode 320 through the second opening 132. In this second configuration, the first signal S_{PDr} would undoubtedly have a higher intensity than the second signal S_{PDt}.

This can be synthetized in the following table.

TABLE 1

| | Order of | | | |
|---|---|---|---|---|
| | magnitude of | | Signal measured | Signal measured |
| | the distance | | by the first | by the second |
| Distance range | range | | photodiode | photodiode |
| Long distance | >30 | mm | Low | Low or null |
| Average distance | [5-30] | mm | High | Average |
| Very short | <5 | mm | Low | Strong |
| distance | | | | |

The orders of magnitude are given by way of illustration and should not be considered as a limitation.

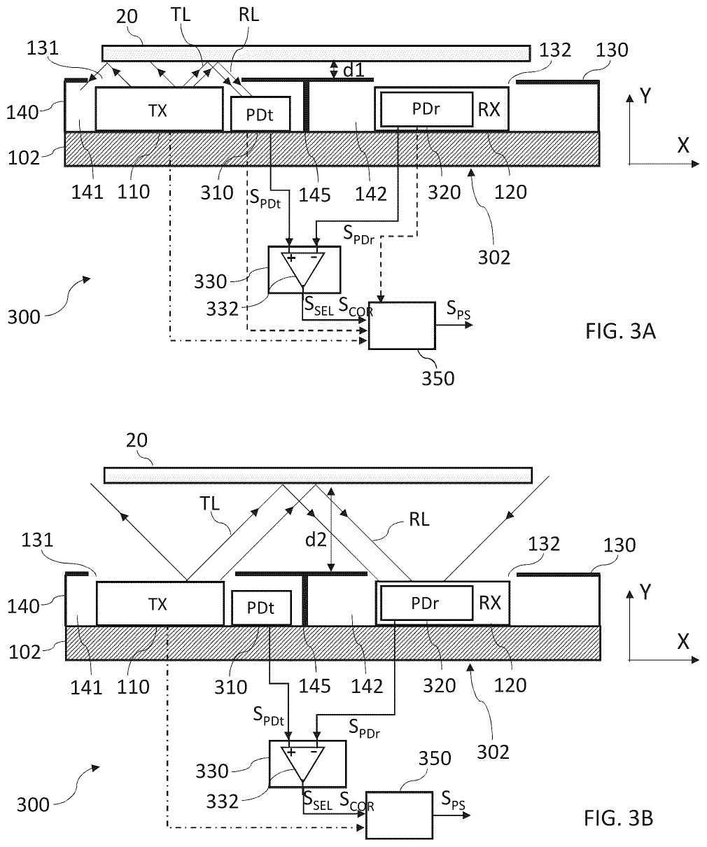

FIG. 4 illustrates, with a flowchart, an example method for detecting proximity implementing a proximity sensing device according to one embodiment. The proximity sensing device is for example, the proximity sensing device 300 shown in FIG. 3A.

In a first step 401 (POWER SUPPLY AND MEASUREMENTS), the proximity sensor 302 is supplied, and the light source 110 starts transmitting the light signals. The light signals can be reflected by an object and captured by the first photodiode PDr and/or the second photodiode PDt.

In a second step 402 (CAPTURE ON PDr+PDt), the first and second photodiodes PDr, PDt respectively generate first and second signals S_{PDr}, S_{PDt}, being transmitted to the selecting circuit 330.

In a third step 403 (PERFORM PDt COUNTS−PDr COUNTS), the selecting circuit 330 performs a comparison between the second signal S_{PDt} and the first signal S_{PDr}.

In a fourth step 404 (DIFFERENCE NEGATIVE?), the selecting circuit 330 determines whether the difference between the second signal and the first signal (S_{PDt}-S_{PDr}) is negative (YES) or not (NO), and:
if the difference is negative (YES), then the first signal is taken into account: this is the first selection 405 (USE PDr COUNTS); or
if the difference is positive (NO), then the second signal is taken into account: this is the second selection 406 (USE PDt COUNTS).

The steps 402 to 404 can be repeated.

In the hereinabove-described example processing method, one determines a difference between the second signal S_{PDt} and the first signal S_{PDr}, and compares this difference with a threshold TH1 being equal to o.

Alternatively, the threshold TH1 can be different from o, and the fourth step 404 might then be: the selecting circuit 330 determines whether the difference between the second signal S_{PDt} and the first signal S_{PDr} is less than the threshold TH1 (YES) or not (NO), and:
if the difference is less than the threshold (YES), then the first signal is taken into account: this is the first selection 405 (USE PDr COUNTS); or
if the difference is higher than the threshold (NO), then the second signal is taken into account: this is the second selection 406 (USE PDt COUNTS).

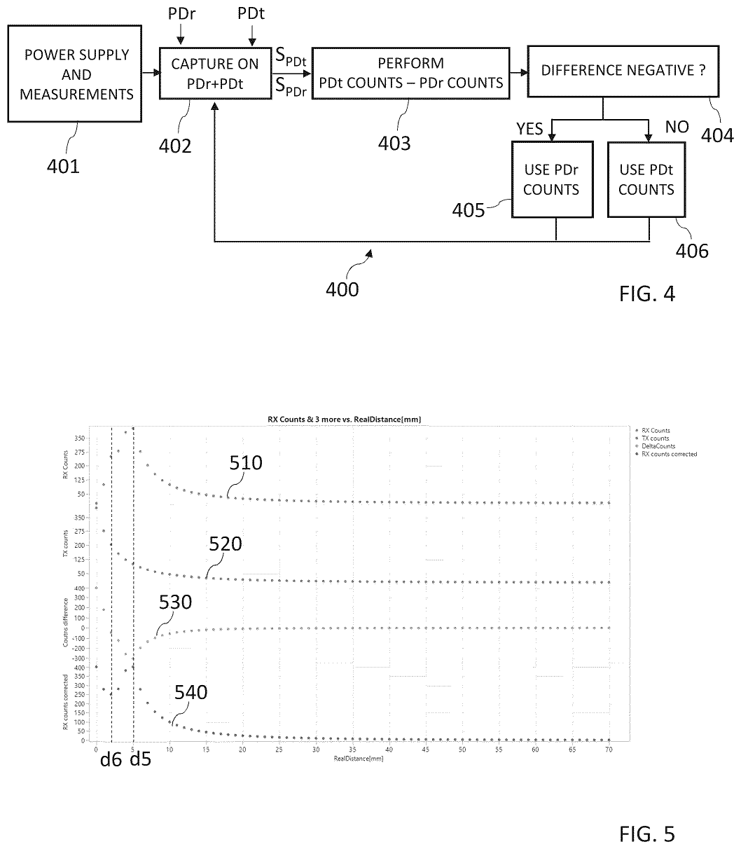

FIG. 5 illustrates an example graph, obtained by simulating, showing signals (counts) generated when implementing the method shown in FIG. 4 as a function of the distance in millimetres (RealDistance [mm]) between the proximity sensor and an object.

A first set of points 510 illustrates first signals (RX counts) generated by the first photodiode. A second set of points 520 illustrates second signals (TX counts) generated by the second photodiode. A third set of points 530 illustrates differential signals (counts difference) obtained by subtracting the first signal to the second signal, TX counts-RX counts, per each distance. A fourth set of points 540 (RX counts corrected) illustrates the signals corrected according to the obtained differential signals.

Like FIG. 2B, the first set of points 510 shows that the first signal generated by the first photodiode PDr rises as the distance decreases down to a distance (fifth distance d5), and that it decreases as the distance increases from the fifth distance d5, but the first signal generated by the first photodiode PDr decreases as the distance decreases from the fifth distance d5, and it rises as the distance increases up to the fifth distance d5. The fifth distance d5 shown in FIG. 5 is equal to around 5 millimetres, but this is not a limitation and this distance might change depending on the proximity sensor, for example.

The second set of points 520 shows that the second signal generated by the second photodiode PDt rises as the distance decreases, and that it decreases as the distance increases.

Upon performing the subtraction between the second signal and the first signal per each distance, one obtains the third set of points 530, and one sees that the differential signal is positive as the distance is less than a sixth distance d6, in the example illustrated less than the fifth distance d5, and negative as the distance is higher than this sixth distance. The sixth distance d6 illustrated in FIG. 5 is equal to around 2-3 millimetres, but this is not a limitation and this distance might change depending on the proximity sensor, for example.

Thus, among the corrected signals corresponding to the fourth set of points 540, below the sixth distance d6, the corrected signal corresponds to the second signal, i.e. to the signal generated by the second photodiode, and above the sixth signal d6, the corrected signal corresponds to the first signal, i.e. to the signal generated by the first photodiode.

Thus, the corrected signal can allow retrieving a signal the intensity of which at very-short-distance is higher than the intensity at long-distance, and cannot be confused with the latter.

The proximity sensing device according to the embodiments can be used in the application described with reference to FIGS. 2A and 2B. In this application, the detection signal S_{PS} can be forwarded to the display screen, or a control circuit of the display screen, for example in order to control its turning off, or its maintaining in off mode, when the detection signal is above the detection threshold THD. Indeed, the proximity sensing device allows the detection signal to be higher at very short distance than at long distance, so that the screen is not erroneously turned on at very short distance.

The embodiments can fit to other applications implementing a proximity sensor, for example:
robotics, e.g. detecting very near objects;
contactless buttons.

The embodiments thus allow very-near-object detection issue to be addressed, for example differentiating a very near object and a far object, and this, using a solution simply implemented, implementing a further photodiode and a selecting circuit that can be very simple. The present solution has no need neither for complex operations between different signals, since a single step of comparing signals is sufficient to perform a selection, nor for storing previous results and/nor a plurality of thresholds, since a single threshold can be sufficient and it can be equal to zero.

The present solution can also allow a requirement of limit of a size of a proximity sensing device to be satisfied, since a cavity already dedicated to the source can be used in order to accommodate therein the further photodiode (second photodiode).

The present solution further allows the detection signal of the proximity sensor to be corrected. For example, in the application to a display screen, it allows not only the screen-off issue at very short distance to be addressed, but also the detection signal of the proximity sensor to be corrected.

Further, the present solution operates without requirement to have a relative move between the proximity sensor and an object.

One embodiment address all or some of the drawbacks of the known proximity sensors.

One embodiment provides a proximity sensing device comprising:
a proximity sensor comprising a light source, a light detector including a first photodiode adapted to generate a first signal, and a second photodiode adapted to generate a second signal, the second photodiode and the light source being separated from the first photodiode with a separator; and
a selecting circuit adapted to compare the first signal with the second signal, and to select a signal from said first and second signals according to the executed comparison.

One embodiment provides a method for detecting proximity implementing a proximity sensing device comprising a proximity sensor comprising a light source, a light detector including a first photodiode, and a second photodiode, the second photodiode and the light source being separated from the first photodiode with a separator;

the method comprising, using a selecting circuit:
comparing a first signal generated by the first photodiode with a second signal generated by the second photodiode; and
selecting a signal from said first and second signals according to the executed comparison.

Each of the following embodiments can apply to the device and/or method.

According to one embodiment, the first photodiode is adapted to generate the first signal when it detects a first light signal transmitted from the light source and reflected by an object, and the second photodiode is adapted to generate the second signal when it detects a second light signal transmitted from the light source and reflected by the object.

According to one embodiment, the selecting circuit comprises a comparator adapted to compare the first and second signals with each other.

According to one embodiment, the selecting circuit, for example a comparator adapted to compare the first and second signals with each other, is configured to generate a selecting signal communicating the selected signal.

According to one embodiment, the selected signal is the second signal if the difference between the second signal and the first signal is higher than a threshold, or the first signal if the difference between the second signal and the first signal is lower than the threshold, the threshold being for example equal to around zero.

According to one embodiment, the selecting circuit is adapted to generate a corrected signal taking a value of the selected signal.

According to one embodiment, the proximity sensing device further comprises a processing device configured to generate a proximity-detection signal according to the signal selected by the selecting circuit.

According to one embodiment, the processing device is adapted to retrieve the corrected signal, the proximity-detection signal being a function of the corrected signal.

According to one embodiment, the processing device is coupled with the selecting circuit, or includes the selecting circuit.

According to one embodiment, the processing device is coupled with the first and second photodiodes.

According to one embodiment, the light source, the light detector, and the second photodiode are disposed under a capping wall of the proximity sensor, for example a top wall of a housing accommodating the light source, the light detector, and the second photodiode.

According to one embodiment, the second photodiode and the light source are disposed side by side along a direction sensibly parallel to the plan of the capping wall.

According to one embodiment, the capping wall includes a first opening in regard of the light source, a second opening in regard of the light detector, for example in regard of the first photodiode, the second photodiode being sensibly disposed under a non-open portion of the capping wall.

According to one embodiment, the second photodiode is disposed between the light source and the first photodiode.

According to one embodiment, the light source, the second photodiode, and the light detector are disposed in a housing comprising a first cavity and a second cavity separated from the first cavity with the separator, the source and the second photodiode being disposed in the first cavity, and the light detector being disposed in the second cavity.

Various embodiments and variants have been described. Those skilled in the art will understand that certain features of these embodiments can be combined and other variants will readily occur to those skilled in the art. In particular, although the embodiments are described in detail for a proximity sensor, they can apply to a sensor of the time-of-flight type.

Finally, the practical implementation of the embodiments and variants described herein is within the capabilities of those skilled in the art based on the functional description provided hereinabove.

What is claimed is:

1. A proximity sensing device comprising:
a proximity sensor comprising a light source, a light detector including a first photodiode adapted to generate a first signal, and a second photodiode adapted to generate a second signal, the second photodiode and the light source being separated from the first photodiode with a separator; and
a selecting circuit adapted to compare the first signal to the second signal, and to select a signal from the first and second signals according to the executed comparison.

2. The proximity sensing device of claim 1, wherein the first photodiode is adapted to generate the first signal when it detects a first light signal transmitted from the light source and reflected by an object, and the second photodiode is adapted to generate the second signal when it detects a second light signal transmitted from the light source and reflected by the object.

3. The proximity sensing device of claim 1, wherein the selecting circuit comprises a comparator adapted to compare the first and second signals with each other.

4. The proximity sensing device of claim 1, wherein the selecting circuit is configured to generate a selecting signal communicating the selected signal.

5. The proximity sensing device of claim 1, wherein the selected signal is the second signal if the difference between the second signal and the first signal is higher than a threshold, or the first signal if the difference between the second signal and the first signal is lower than the threshold, the threshold being equal to around zero.

6. The proximity sensing device of claim 1, wherein the selecting circuit is adapted to generate a corrected signal taking a value of the selected signal.

7. The proximity sensing device of claim 6, further comprising a processing device configured to generate a proximity-detection signal according to the signal selected by the selecting circuit.

8. The proximity sensing device of claim 7, wherein the processing device is adapted to retrieve the corrected signal, the proximity-detection signal being a function of the corrected signal.

9. The proximity sensing device of claim 7, wherein the processing device is coupled to the selecting circuit, or includes the selecting circuit.

10. The proximity sensing device of claim 7, wherein the processing device is coupled to the first and second photodiodes.

11. The proximity sensing device of claim 1, wherein the light source, the light detector, and the second photodiode are disposed under a capping wall of the proximity sensor, the capping wall comprising a top wall of a housing accommodating the light source, the light detector, and the second photodiode.

12. The proximity sensing device of claim 11, wherein the second photodiode and the light source (110) are disposed side by side along a direction substantially parallel to a plane of the capping wall.

13. The proximity sensing device of claim 11, wherein the capping wall includes a first opening corresponding to the light source, a second opening corresponding to the first photodiode of the light detector, the second photodiode being substantially disposed under a non-open portion of the capping wall.

14. The proximity sensing device of claim 1, wherein the second photodiode is disposed between the light source and the first photodiode.

15. The proximity sensing device of claim 1, wherein the light source, the second photodiode, and the light detector are disposed in a housing comprising a first cavity and a second cavity separated from the first cavity with the separator, the light source and the second photodiode being disposed in the first cavity, and the light detector being disposed in the second cavity.

16. A proximity sensing device comprising:
a housing comprising a first cavity and a second cavity, wherein the first cavity is separated from the second cavity with a separator;
a proximity sensor comprising:
a light source disposed within the first cavity;
a light detector disposed within the second cavity, the light detector including a first photodiode adapted to generate a first signal; and
a second photodiode within the first cavity, the second photodiode being adapted to generate a second signal;
a selecting circuit coupled to the proximity sensor, wherein the selecting circuit comprises a comparator adapted to compare the first signal to the second signal, and to select a signal from the first and second signals according to the executed comparison; and
a processing device coupled to the selecting circuit, wherein the processing device is configured to generate a proximity-detection signal according to the signal selected by the selecting circuit.

17. A method for detecting proximity implementing a proximity sensing device comprising a proximity sensor comprising a light source, a light detector including a first photodiode, and a second photodiode, the second photodiode and the light source being separated from the first photodiode with a separator, the method comprising, using a selecting circuit:
comparing a first signal generated by the first photodiode with a second signal generated by the second photodiode; and
selecting a signal from the first and second signals according to the executed comparison.

18. The method of claim 17, further comprising:
generating, by the first photodiode, the first signal when the first photodiode detects a first light signal transmitted from the light source and reflected by an object; and
generating, by the second photodiode, the second signal when the second photodiode detects a second light signal transmitted from the light source and reflected by the object.

19. The method of claim 17, further comprising, using the selecting circuit:
generating a corrected signal taking a value of the selected signal; and
communicating the corrected signal to a processing device coupled to the selecting circuit.

20. The method of claim 19, wherein the selected signal is the second signal if the difference between the second signal and the first signal is higher than a threshold, or the first signal if the difference between the second signal and the first signal is lower than the threshold, the threshold being equal to around zero.
